(19) United States
(12) Patent Application Publication
(10) Pub. No.: US 2023/0304809 A1
(43) Pub. Date: Sep. 28, 2023

(54) POWER MANAGEMENT OF INDUSTRIAL ELECTRIC VEHICLES

(71) Applicant: Wrightspeed, Inc., Alameda, CA (US)

(72) Inventors: Andrew Schini, Oakland, CA (US); Ian Sowden, San Francisco, CA (US)

(73) Assignee: Wrightspeed, Inc., Alameda, CA (US)

(21) Appl. No.: 17/656,406

(22) Filed: Mar. 24, 2022

(51) Int. Cl. G01C 21/34; G01C 21/36; B60L 58/13

(52) U.S. Cl. CPC G01C 21/3469; G01C 21/3492; G01C 21/3461; G01C 21/3691; B60L 58/13; B60L 2200/18; B60L 2240/12; B60L 2240/26; B60L 2240/34; B60L 2240/64; B60L 2240/66; B60L 2240/68; B60L 2240/70; B60L 2260/52; B60L 2260/54

(57) ABSTRACT

Described herein are industrial electric vehicles and methods of operating thereof. An industrial electric vehicle comprises a battery and a range extender. The range extender is operated while the industrial electric vehicle travels through each range-extender portion and, in some examples, not in other route portions. Each range-extender portion is identified based on various route parameters such as range-extender exclusion zones, uphill and downhill portions, expected vehicle speeds and weight, expected traffic, and the like. Using specific range-extender portions allows minimizing the total use of the range extender, saving fuel, reducing emissions, and reducing noise in certain areas. In some examples, route parameters are aggregated from a fleet of industrial electric vehicles, which have been driven on the same route. In some examples, range-extender portions are being determined or updated while the industrial electric vehicle travels along the route, e.g., based on revised route parameters and/or vehicle parameters.

### BACKGROUND

Electric vehicles are becoming more popular, especially for industrial applications. Some examples of industrial electric vehicles include, but are not limited to, buses and delivery trucks. Electric vehicles, even the ones equipped with range extenders, produce less pollution and noise and tend to be more cost-effective to operate. For example, electric vehicles are capable of regenerative braking. Furthermore, electric motors are generally more efficient than internal combustion engines (ICEs) and do not need to idle when the vehicles temporarily stop. However, charging an electric vehicle requires a long time. Furthermore, charging may not be available while an industrial electric vehicle is on its route. For example, an electrical bus may need to return to a bus depot for several hours for recharging.

What is needed are new methods and systems to ensure continuous operations of industrial electric vehicles along their routes.

### SUMMARY

Described herein are industrial electric vehicles and methods of operating thereof. An industrial electric vehicle comprises a battery and a range extender. The range extender is operated while the industrial electric vehicle travels through each range-extender portion and, in some examples, not in other route portions. Each range-extender portion is identified based on various route parameters such as range-extender exclusion zones, uphill and downhill portions, expected vehicle speeds and weight, expected traffic, and the like. Using specific range-extender portions allows minimizing the total use of the range extender, saving fuel, reducing emissions, and reducing noise in certain areas. In some examples, route parameters are aggregated from a fleet of industrial electric vehicles, which have been driven on the same route. In some examples, range-extender portions are being determined or updated while the industrial electric vehicle travels along the route, e.g., based on revised route parameters and/or vehicle parameters.

Provided is a method of operating an industrial electric vehicle comprising a battery and a range extender. In some examples, the method comprises receiving route parameters corresponding to a route designated for the industrial electric vehicle, determining one or more range-extender portions on the route based on at least the route parameters, and driving the industrial electric vehicle along the route. The range extender is instructed to operate while the industrial electric vehicle travels through each of the one or more range-extender portions on the route.

In some examples, the route parameters comprise at least one of one or more range-extender exclusion zones on the route, one or more downhill portions of the route, one or more uphill portions of the route, an expected vehicle speed profile along the route, an expected vehicle weight profile along the route, and historical traffic information for the route. For example, the one or more range-extender exclusion zones comprise at least one of a pollution-restricted area and a noise-restricted area.

In some examples, determining one or more range-extender portions on the route is further based on weight coefficients, each assigned to a different one of the route parameters. In the same or other examples, determining one or more range-extender portions on the route is further determined to reduce a total fuel consumption along the route.

In some examples, the one or more range-extender portions on the route are further determined based on one or more external inputs comprising at least one of expected weather conditions and expected traffic conditions.

In some examples, the one or more range-extender portions on the route are further determined based on operating instructions, received from a central data system and developed based operating reports from an industrial electric vehicle fleet previously traveling the route.

In some examples, the method further comprises, prior to driving the industrial electric vehicle, preconditioning the industrial electric vehicle while the industrial electric vehicle is connected to an external charging station. For example, preconditioning the industrial electric vehicle comprising bringing a cabin temperature of the industrial electric vehicle to a set range. In some examples, the method further comprises determining an initial state of charge of the battery based on the one or more range-extender portions.

In some examples, determining the one or more range-extender portions on the route based on the route parameters is performed before driving the industrial electric vehicle along the route. In the same or other examples, receiving the route parameters and determining the one or more range-extender portions is performed continuously while driving the industrial electric vehicle along the route.

In some examples, receiving the route parameters and determining the one or more range-extender portions is performed, at least in part, while driving the industrial electric vehicle along the route. More specifically, determining the one or more range-extender portions, while driving the industrial electric vehicle along the route, can be further performed based on a current SOC of the battery.

In some examples, the method further comprises changing the route to minimize the one or more range-extender portions on the route. In the same or other examples, the method further comprises, after driving the industrial electric vehicle along the route, transmitting an operating report to a central data system, the operating report comprising the route and the one or more range-extender portions used on the route.

In some examples, determining the one or more range-extender portions is performed at the industrial electric vehicle. In the same or other examples, determining the one or more range-extender portions is performed at a central data system, commutatively coupled to the industrial electric vehicle. The one or more range-extender portions are transmitted to the industrial electric vehicle before or while driving the industrial electric vehicle along the route.

Also provided is an industrial electric vehicle comprising a battery, a range extender, and a system controller, configured to receive route parameters corresponding to a route designated for the industrial electric vehicle, determine one or more range-extender portions on the route based on the route parameters, and operate the range extender while the industrial electric vehicle travels through each of the one or more range-extender portions on the route.

Also provided is an industrial electric vehicle system comprising a central data system and multiple industrial electric vehicles, each communicatively coupled to the central data system and comprising a battery, a range extender, and a system controller. The system controller is configured to receive, from the central data system route parameters corresponding to a route designated for the industrial electric vehicle, determine one or more range-extender portions on the route based on the route parameters, and operate the range extender while the industrial electric vehicle travels through each of the one or more range-extender portions on the route.

These and other embodiments are described further below with reference to the figures.

### BRIEF DESCRIPTION OF THE DRAWINGS

FIG. 1 is a block diagram of an industrial electric vehicle showing various power train components and interactions among these components, in accordance with some examples.

FIG. 2 is a schematic illustration of a route traveled by an industrial electric vehicle, showing various portions of the route, in accordance with some examples.

FIG. 3A is a block diagram of an industrial electric vehicle showing various control components and interactions among these components, in accordance with some examples.

FIG. 3B is a schematic illustration of an industrial electric vehicle system illustrating a fleet of industrial electric vehicles, each communicatively coupled to a central data system.

FIG. 3B is a schematic illustration of an industrial electric vehicle system illustrating a fleet of industrial electric vehicles, each communicatively coupled to a central data system.

FIG. 4A illustrates one example of power profiles and battery's state of charge profile while operating an industrial electric vehicle.

FIG. 4B illustrates another example of power profiles and battery's state of charge profile while operating an industrial electric vehicle.

FIG. 5 is a process flowchart corresponding to a method of operating an industrial electric vehicle, in accordance with some examples.

FIG. 6 is a block diagram of a computer system, which can be used as a system controller of an industrial electric vehicle and/or a central data system, in accordance with some examples.

### DETAILED DESCRIPTION

In the following description, numerous specific details are set forth in order to provide a thorough understanding of the presented concepts. The presented concepts may be practiced without some or all of these specific details. In other instances, well-known process operations have not been described in detail so as to not unnecessarily obscure the described concepts. While some concepts will be described in conjunction with the specific embodiments, it will be understood that these embodiments are not intended to be limiting.

### INTRODUCTION

Industrial electric vehicles often travel the same route or a known route, such as a bus route, a delivery route, and the like. Some parameters of a route can be identified before or while the industrial electric vehicle travels on this route, and these parameters can be used to control various operating aspects of the industrial electric vehicle. For example, various route parameters can be used to identify one or more range-extender portions along the route. A range-extender portion is a portion of the route where the operation of the vehicle's range extender is allowed. In other portions of the route, the operation of the vehicle's range extender can be undesirable or even prohibited. For example, a route can include one or more range-extender exclusion zones representing pollution-restricted areas and/or noise-restricted areas, such as certain residential areas, enclosed areas (e.g., bus depots, tunnels), parks, hospitals, and the like. Furthermore, the predictive operation of the vehicle's range extender can help to reduce the capacity of the vehicle's battery, reduce undesirable power dumps, reduce the power output of the range extender, reduce noise in desired areas, limit stops for recharging and/or refueling, and reduce the number of times when the range extender needs to be started and used, among other benefits.

As noted above, each range-extender portion is identified based on various route parameters such as range-extender exclusion zones, uphill and downhill portions, expected vehicle speeds and weight, expected traffic, and the like. For example, the range extender can start operating before the industrial electric vehicle approaches an uphill portion of the route to ensure the vehicle has enough energy to complete this portion. It should be noted that the energy to propel the vehicle can come from two sources: (1) the vehicle's battery and (2) the vehicle's range extender. The vehicle's range extender may not be able to power the vehicle through this uphill portion. As such, the vehicle's battery has to have a sufficient state of charge before starting this uphill portion to assist with the power delivery, which in some examples is ensured by operating before the industrial electric vehicle approaches the uphill portion. In another example, the range extender can be turned off preemptively when the industrial electric vehicle approaches a downhill portion of the route. While driving downhill, the industrial electric vehicle can use regenerative braking and recharge the battery. As such, the battery's state of charge should be sufficiently low to accommodate all generated power.

Overall, operating the range extender in specific range-extender portions allows minimizing the total use of the range extender, reducing the battery capacity, reducing the power output of the range extender, saving fuel, reducing emissions, and/or reducing noise in certain areas.

### Vehicle Examples

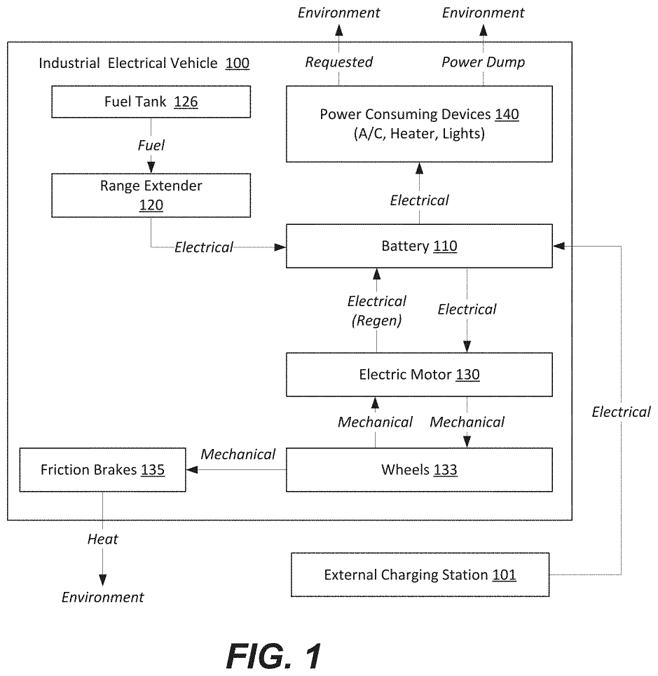

FIG. 1 illustrates power management in industrial electric vehicle 100 using various energy conversion (mechanical-electrical and mechanical-thermal) processes and power transfers. Specifically, industrial electric vehicle 100 comprises battery 110, range extender 120, electric motor 130, and various power-consuming devices 140. These are primary energy generating, energy-consuming, and energy-storing components onboard of industrial electric vehicle 100. Range extender 120 receives fuel (e.g., gasoline, diesel, natural gas) from fuel tank 128 and generates electrical energy when operating. This generated electrical energy is supplied to battery 110 for storage and/or electric motor 130 for propelling industrial electric vehicle 100. Electric motor 130 can also receive electrical energy from battery 110. Electric motor 130 generates mechanical energy applied to wheels 133. Electric motor 130 is also configured to operate in a regenerative mode, e.g., to slow down industrial electric vehicle 100 and/or to control the speed when driving downhill. In this regenerative mode, mechanical energy is applied by wheels 133 to electric motor 130. Electric motor 130 converts this mechanical energy into electrical energy and supplies the electrical energy to battery 110. In some examples, the regenerative mode may not be sufficient to slow down industrial electric vehicle 100 or battery 110 may not be available to receive electrical charge (e.g., at a fully charged state). In these examples, some or all mechanical energy is transferred to friction brakes 135, which convert the mechanical energy into heat and dissipate this heat into the environment. In general, the operation of friction brakes 135 should be minimized to reduce energy losses to the environment and to extend the operating lifetime of friction brakes 135.

Power-consuming devices 140 can include an air-conditioner, a heater, various lights, and the like. Power-consuming devices 140 receive electrical energy from battery 110 and/or ranger extender 120 for various requested operations of the devices. In some examples, power-consuming devices 140 can be used for excess power dump. For example, electric motor 130 may be operated in a regenerative mode when battery 110 is fully charged. The excess electrical energy can be sent to power-consuming devices 140. In a specific example, an air-conditioner and a heater can be operated at the same time, without significant changes to the temperature conditions of industrial electric vehicle 100, to consume excess electrical energy.

Battery 110 is also configured to receive electrical energy from external charging station 101, e.g., when industrial electric vehicle 100 is parked near and plugged to external charging station 101. This energy may be used to charge battery 110 and/or operate power-consuming devices 140 (e.g., to bring the temperature of industrial electric vehicle 100 to a set range) while industrial electric vehicle 100 is parked.

One having ordinary skill in the art would understand that industrial electric vehicle 100 can include various other components, such as inverter, power converters, and such that may be not shown in FIG. 1. Furthermore, one having ordinary skill in the art would understand that various examples of the described components are within the scope. For example, battery 110 can have various battery chemistries, battery pack configurations, capacities, and the like. Range extender 120 can take a fuel cell assembly or a combination of an internal combustion engine (e.g., a piston engine, a turbine) and a generator.

### Route Examples

Industrial electric vehicle 100 is configured to travel along route 190, which is at least partially known before or during this travel. Some examples of route 190 include, but are not limited to, a bus route, a package-delivery route, refuse pickup, and the like. It should be noted that delivery routes need not be package specific (e.g., delivery of fungible products like). Some specific examples include goods delivery, liquid/gas tanker vehicles, refrigerated food delivery, and livestock transfer. Likewise, a bus route could encompass more than just a traditional bus route and include customer/employee shuttle and other like applications.

As shown, route 190 may include one or more uphill portions 194, where additional power (beyond what can be provided by battery 110) may be required for the propulsion of industrial electric vehicle 100. Furthermore, route 190 may include one or more downhill portions 193 where industrial electric vehicle 100 can be operated in a regenerative mode, generating electrical power and using this generated power to, e.g., recharge battery 110. In some examples, route 190 comprises one or more range-extender exclusion zones 192 where range extender 120 should not be operated. Range-extender exclusion zones 192 can be created because of the noise and/or pollution created during the operation of range extender 120. Some examples of range-extender exclusion zones 192 include, but are not limited to, school zones, parks, hospital areas, residential areas, bus stops, tunnels, malls (e.g., entertainment/dining precincts). It should be noted that range-extender exclusion zones 192 can be permanent or could be identified based on specific days, time periods, events in the areas, and the like. In some examples, different range-extender exclusion zones 192 have different priority levels, selected based on the impact of the range extender operation on each zone. In general, range-extender exclusion zones 192 comprise at least one of a pollution-restricted area and a noise-restricted area.

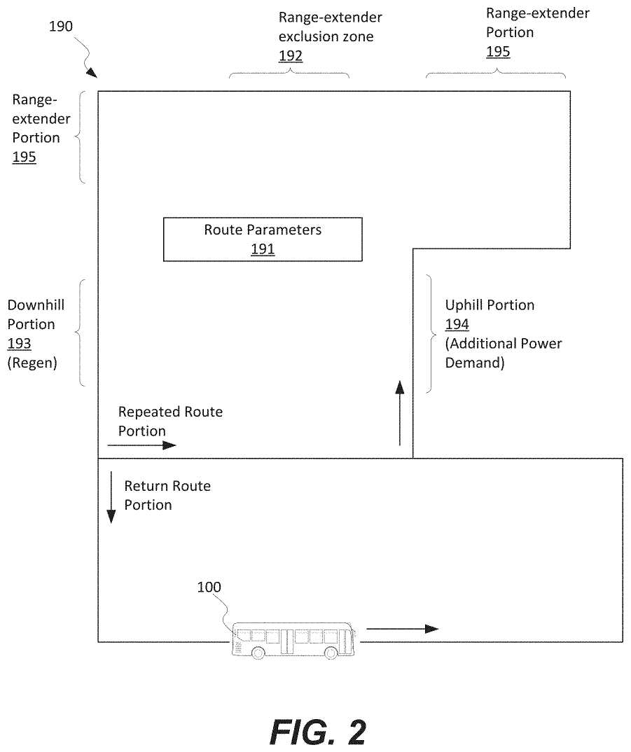

FIG. 2 also illustrates one or more range-extender portions 195 during which range extender 120 is instructed to operate. Range-extender portions 195 can be determined based on various parameters associated with route 190. Range-extender portions 195 can be determined to ensure a more efficient operation of range extender 120.

### System Controller Examples

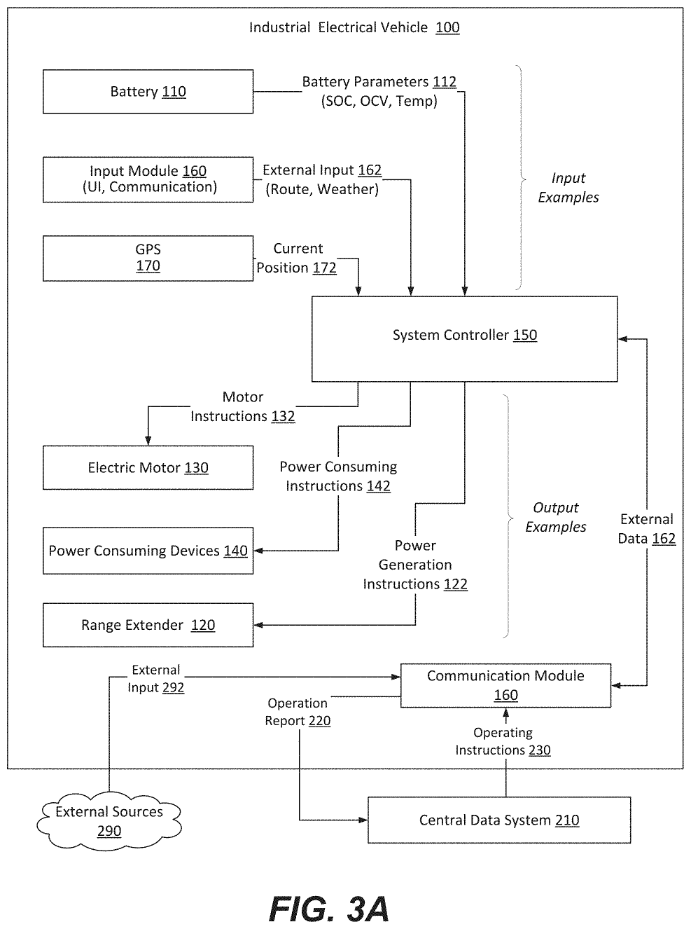

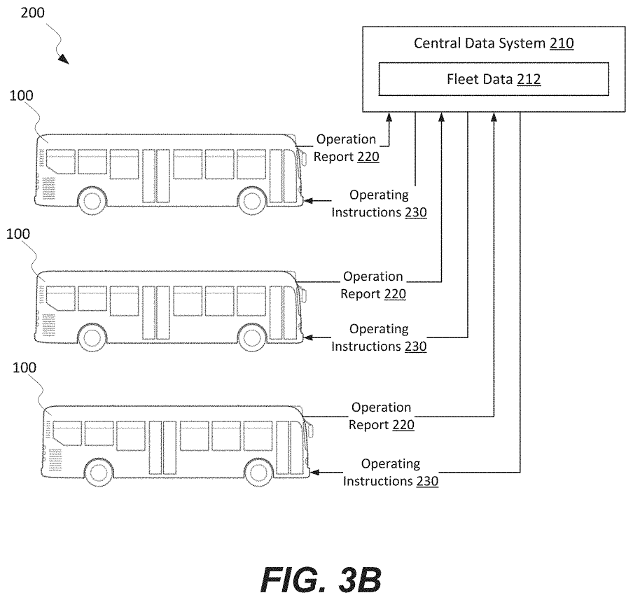

FIG. 3A is a schematic block diagram of various control aspects within industrial electric vehicle 100. Industrial electric vehicle 100 comprises system controller 150, communicatively coupled to battery 110, range extender 120, electric motor 130, and power-consuming device 140. For example, battery 110 can supply various battery parameters 112, such as the state of charge (SOC), open-circuit voltage (OCV), and/or temperature of battery 110 to system controller 150. System controller 150 uses battery parameters 112 as inputs for, e.g., determining one or more target range-extender portions 195 as further described below.

In some examples, system controller 150 sends power generation instructions 122 to range extender 120. For example, power generation instructions 122 can include instructions to start the operation of range extender 120, to stop the operation of range extender 120, and/or the power level with which range extender 120 should operate. In some examples, a specific power level is not provided, and range extender 120 is operated in the most efficient regime determined for this type of range extender 120. The start and stop instructions are based on target range-extender portions 195. For example, when industrial electric vehicle 100 enters any one of target range-extender portions 195, system controller 150 instructs range extender 120 to turn on. When industrial electric vehicle 100 leaves any one of target range-extender portions 195, system controller 150 instructs range extender 120 to turn off.

In some examples, system controller 150 sends motor instructions 132 to electric motor 130. For example, system controller 150 can receive input from a gas pedal of industrial electric vehicle 100 and, in a more specific example, also from a brake pedal. System controller 150 determines motor instructions 132 based on this input. In some examples, system controller 150 also uses additional inputs (e.g., the temperature of electric motor 130, battery parameters 112) when determining motor instructions 132.

In some examples, system controller 150 sends power-consuming instructions 142 to power-consuming devices 140. These power-consuming instructions 142 may be generated based on driver inputs, e.g., turning on the air-conditioner, heater, lights, and the like. In some examples, power-consuming instructions 142 are generated independently from driver inputs. For example, industrial electric vehicle 100 operates in a regenerative mode (e.g., while traveling downhill) while the SOC of battery 110 is near the maximum limit. System controller 150 can instruct one or more power-consuming devices 140 to temporarily turn on (e.g., run the heater, run both the heater and air-conditioner) to dump the power.

In some examples, other components of industrial electric vehicle 100 and even external components are communicatively coupled to system controller 150. For example, industrial electric vehicle 100 can be equipped with input module 160 for providing various external input 162 to system controller 150. Some examples of external input 162 include, but are not limited to, destination, route information (e.g., incline portions, decline portions, range extender exclusion zones), weather information, traffic information, and the like. Input module 160 can be in a form of a user interface (e.g., a touch screen). A driver of industrial electric vehicle 100 can use input module 160 to provide various forms of external input 162 to system controller 150.

Industrial electric vehicle 100 can be also equipped with global positioning system 170 (GPS) for determining current position 172 of industrial electric vehicle 100 on route 190 and for communicating this current position 172 to system controller 150. System controller 150 can use this current position 172 to determine, at least in part, power generation instructions 122 for range extender 120.

Furthermore, industrial electric vehicle 100 can be also equipped with communication module 180 for transferring various types of external data 182 to and form system controller 150. In some examples, communication module 180 is configured to form a communication link with external sources 290 (e.g., weather service servers, traffic information servers) to receive various external input 292.

In some examples, communication module 180 is also configured to form communication links with central data system 210, which can also establish communication links with other industrial electric vehicles as, e.g., is schematically shown in FIG. 3B. Specifically, FIG. 3B illustrates industrial electric vehicle system 200 comprising multiple industrial electric vehicles 100, each communicatively coupled to central data system 210. For example, central data system 210 can manage various data (e.g., fleet data 212) for multiple industrial electric vehicles 100 forming the same fleet (e.g., operating along the same route). Industrial electric vehicles 100 or, more specifically, communication module 180 of each industrial electric vehicle 100 can provide operation report 220 (e.g., actual range-extender portions used by industrial electric vehicle 100) to central data system 210. Communication module 180 can receive various operating instructions 230 (e.g., target range-extender portions to be used by industrial electric vehicle 100) from central data system 210. Central data system 210 can generate these operating instructions 230 by aggregating (over time) operation reports 220 from multiple industrial electric vehicles 100. For example, machine learning can be used for this purpose.

### Examples of Operating Industrial Vehicles

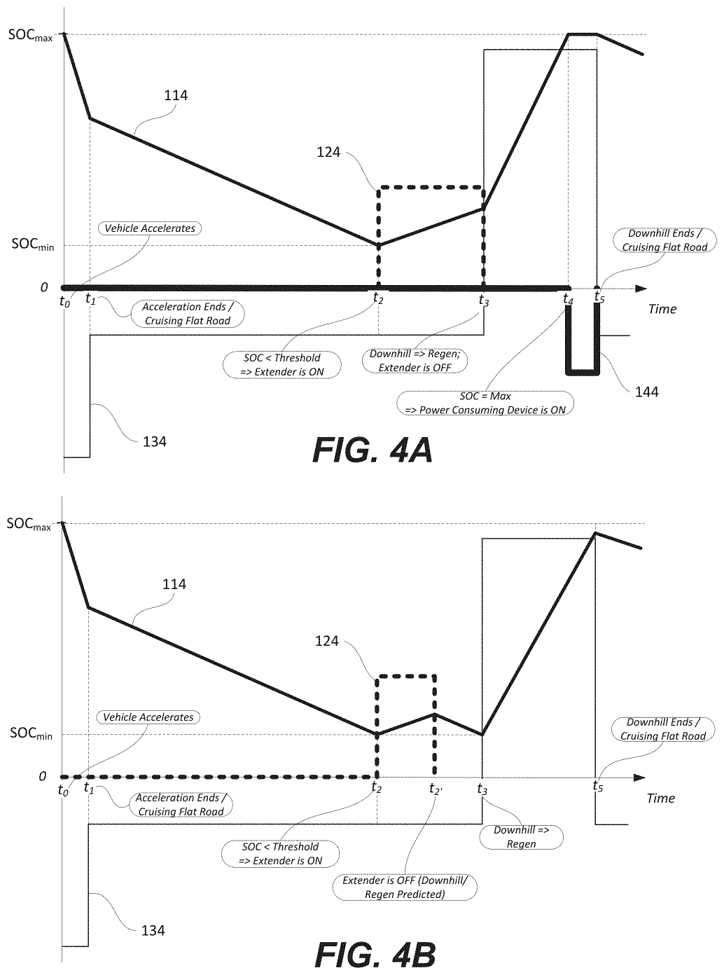

FIG. 4A illustrates one example of power profiles and battery's state of charge profile while operating industrial electric vehicle 100 along route 190. Specifically, line 114 represents the state of charge of battery 110, line 124 represents the power output of range extender 120, line 134 represents the power consumed by electric motor 130, and line 144 represents the power consumed by power-consuming devices 140. At t₀ when industrial electric vehicle 100 starts driving, the state of charge of battery 110 can be at the maximum (SOC_{MAX}). Industrial electric vehicle 100 accelerates between t₀ and t₁, which corresponds to a significant power (line 134) drawn by electric motor 130. This drawn power rapidly discharges battery 110, referring to the slope of line 114. At t₁, industrial electric vehicle 100 stops accelerating and proceeds with cruising on a flat portion of route 190. The power (line 134) drawn by electric motor 130 is significantly less, resulting in a slower discharge (the slope of line 114) of battery 110. At t₂, the state of charge (line 114) of battery 110 reaches the minimum (SOC_{MIN}), and range extender 120 is turned (line 124). In this example, the power from range extender 120 is sufficient to both propel industrial electric vehicle 100 and recharge battery 110 (e.g., line 114 is sloping upwards). At t₃, industrial electric vehicle 100 reaches a downhill portion of route 190, and electric motor 130 switches to regenerative braking (represented by line 134 shows a high positive value). Range extender 120 is turned off (line 124), while the power generated by regenerative braking is supplied to recharge the battery (e.g., line 114 is sloping upwards). At t₄, battery 110 is charged to the maximum (SOC_{MAX}) and can no longer receive additional power. However, industrial electric vehicle 100 is still on the downhill portion of route 190. As noted above, the user of friction brakes 135 is not desirable due to the limited operating time (e.g., possible overheating) and rapid wear. As such, the power generated by regenerative braking is supplied to power-consuming devices 140 (line 144) that can be configured to dump this excess energy into the environment. This power dump continues until t₅, which corresponds to the end of the downhill portion of route 190. It should be noted that this dumped power is wasted and can not be recouped. It should be also noted that this dumped power can be reduced or eliminated if range extender 120 can be turned off earlier, e.g., before reaching the downhill portion at t₃, as will now be illustrated with reference to FIG. 4B.

Specifically, FIG. 4B illustrates another example of power profiles and battery's state of charge profile while operating industrial electric vehicle 100. Up to t_{2′} industrial electric vehicle 100 is operated similarly in both examples, i.e., starting with battery 110 charged to the maximum (SOC_{MAX}) at t0, accelerating until t₁, and turning on range extender 120 at t₂. However, in FIG. 4B example, range extender 120 is turned off at t_{2′} and before reaching the downhill portion at t₃. This preemptive shutdown of range extender 120 is done based on the knowledge of the upcoming downhill portion and timed in such a way that no power dump is needed while electric motor 130 is operated in a regenerative braking mode and supplies power to battery 110. In fact, the state of charge (line 114) of battery 110 approaches the maximum (SOC_{MAX}) by the end of the downhill portion at t₅ but never reaches it before this endpoint. As such, no power needs to be dumped. It should be noted that in FIG. 4B example range extender 120 is operated for a much shorter period of time (from t₂ to t_{2′}) than in FIG. 4A example (from t₂ to t₃) resulting in fuel saving, lower pollution, and lower operating costs. These savings are achieved by considering route parameters (e.g., the location and conditions of the downhill portion) and determining a range-extender portion (i.e., from t₂ to t_{2′} in FIG. 4B).

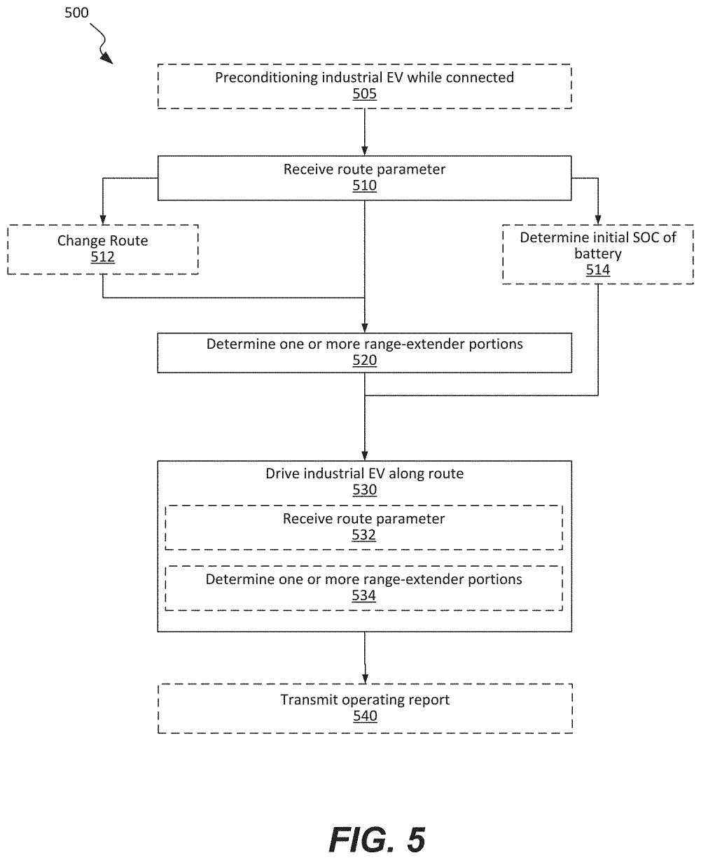

While FIGS. 4A and 4B illustrate just one example of using route parameters for determining range-extender portions, various other examples are within the scope as will now be described with reference to FIG. 5. Specifically, FIG. 5 is a process flowchart corresponding to method 500 of operating industrial electric vehicle 100, in accordance with some examples. Various features of industrial electric vehicle 100 are described above. For example, industrial electric vehicle 100 comprises battery 110 and range extender 120. Industrial electric vehicle 100 is designated to travel route 190, which has various route parameters 191 associated with route 190.

In some examples, method 500 comprises (block 505) preconditioning industrial electric vehicle 100. This operation can be performed while industrial electric vehicle 100 is still connected to external charging station 101 such that the electrical power can be supplied to industrial electric vehicle 100. For example, industrial electric vehicle 100 can be preconditioned to achieve a set temperature range in one or more compartments of industrial electric vehicle 100 (e.g., a passenger compartment, a cargo compartment). In a more specific example, industrial electric vehicle 100 is a bus that was parked or otherwise was not operational for a period of time. The temperature inside the passenger compartment may be the same or close to the environment temperature, which may be above or below the set temperature range (e.g., suitable for passengers on the bus). If the bus is allowed to leave its parking location (e.g., a bus depot) with that passenger compartment temperature (i.e., being outside of the set temperature range), then significant energy would be needed (e.g., by discharging battery 110 and/or operating range extender 120, both of which are not desirable) to bring this temperature within the set range. With the limited capacity of battery 110, this power (used for heating/cooling the bus) will reduce the bus' range, which is not desirable. By preconditioning the bus, while it is still connected to external charging station 101, the bus' range is not impacted by this conditioning, e.g., the battery can be charged to the maximum (SOC_{MAX}) upon leaving the depot and not used for preconditioning, which is completed before leaving the depot. As such, at least some preconditioning of industrial electric vehicle 100 is performed while the energy still can be supplied from external charging station 101. In some examples, the SOC limits depend on various real time variables such as temperature, traffic conditions. For example, a bus travelling on a cold day and expected to stay in traffic for a long time can be charged to a higher overall SOC.

Method 500 comprises (block 510) receiving route parameters 191 corresponding to route 190 designated for industrial electric vehicle 100. Some examples of route parameters are described above, such as one or more range-extender exclusion zones 192 on route 190, one or more downhill portions 193 of route 190, one or more uphill portions 194 of route 190, an expected vehicle speed profile along route 190, an expected vehicle weight profile along route 190, and historical traffic information for route 190, real time and historical traffic information, current and forecast temperature, road conditions (e.g. snow). Overall, route parameters 191 may all impact the range extender operation duration to ensure enough charge for range-extender exclusion zones 192. These route parameters 191 are used in later operations to at least determine one or more range-extender portions 195. Each route parameter can be identified with a specific location along route 190, e.g., a starting point and ending point. Some route parameters can have additional characteristics. For example, range-extender exclusion zones 192 can have associated time when range extender 120 can not be used in these range-extender exclusion zones 192 (e.g., night time in residential areas, school hours around schools, and like). Downhill portions 193 and uphill portions 194 can have associated grade ratings, which can be used to estimate expected energy production/consumption in these portions while industrial electric vehicle 100 drives through these portions. In some examples, route parameters 191 have different weight coefficients, e.g., representing the importance of this parameter when determining one or more range-extender portions 195. Various examples of different weight coefficients are described below.

In some examples, route parameters 191 are received from central data system 210, e.g., via a communication link between industrial electric vehicle 100 and central data system 210. As described above, central data system 210 can be used to aggregate, store, and process information about route 190 (as well as other routes). For example, this information can be provided from a fleet of industrial electric vehicles and/or other services (e.g., one or more mapping platforms, traffic services, and the like). In some examples, route 190 is associated with an annotated map comprising various route parameters 191 described herein (e.g., specific routes/roads, elevations/grades, speed limits, expected traffic conditions, etc.) The base map for this annotated map may or may not be sourced externally (e.g., generally available geospatial data). In some examples, range-extender exclusion zones 192 are added (e.g. schools, residential areas, churches, entertainment and alfresco dining areas etc.). Range-extender exclusion zones 192 can be generated based on publically available information, e.g., objects associated with route 190. In some examples, real time data is collected (e.g., traffic conditions, weather etc). All of this data can be combined with mission criteria (e.g., payload weight etc.). For predictable routes (e.g., garbage truck, fixed bus/shuttle route), this aggregate data can be used to determine one or more range-extender portions 195 on route 190. For example, if the traffic conditions in one of range-extender exclusion zones 192 have worsened enroute on a particularly cold day, then the planning algorithm could forecast a longer duration in that exclusion zone with an increased demand for the cabin heating. As such, one or more range-extender portions 195 preceeding this exclusion zone can be extended. For flexible routes (e.g., home/business delivery, depot to depot delivery, port to depot delivery etc.) various route parameters 191 described above can be also used in route planning both in terms of route viability and to optimize for travel time, energy consumption, time spent in quite/congestion zones etc.

In some examples, method 500 comprises (block 512) changing route 190 to minimize one or more range-extender portions 195 on route 190. More specifically, route 190 can be changed to reduce the total operating time of range extender 120 thereby reducing the fuel consumption of industrial electric vehicle 100 along route 190.

Method 500 comprises (block 520) determining one or more range-extender portions 195 on route 190 based on route parameters 191. This determination operation can involve multiple targets, such as (1) maximizing the regenerative braking while industrial electric vehicle 100 travels along route 190 to recoup the most energy, (2) completing route 190 with battery 110 at a minimum charge state (e.g., SOC about 0%) at the end of route 190, (3) minimizing the use of range extender 120 in all range-extender exclusion zones 192 on route 190 or, more specifically, to reduce the total fuel consumption along route 190, (4) minimizing the non-recoverable energy uses (e.g., the use of friction brakes 135, power dumps, and the like). Some of the targets are complementary to each other. For example, maximizing the regenerative braking effectively reduces the use of friction brakes 135. It should be noted that each of these targets can be assigned various weights, representing the importance of each target. For example, if one or more range-extender exclusion zones 192 are particularly sensitive to the operation of range extender 120 (e.g., due to the noise, exhaust) in comparison, for example, to the total fuel consumption of industrial electric vehicle 100, then the weight assigned to range-extender exclusion zones 192 can be greater than the weight assigned to the regenerative braking. Furthermore, different range-extender exclusion zones 192 can have different weights (e.g., residential areas during night hours can have a higher weight than park areas during the day). Each of these targets will now be described in more detail.

Regenerative braking recoups at least some energy that was previously used to accelerate industrial electric vehicle 100. Assuming that route 190 has a set energy requirement for industrial electric vehicle 100 to complete route 190, maximizing the regenerative braking effectively reduces the energy needed from other sources, e.g., battery 110 and fuel tank 128. Furthermore, since battery 110 has a set capacity, which is typically not sufficient on its own to propel industrial electric vehicle 100 along the entire route 190, maximizing the regenerative braking effectively reduces the fuel consumption, which is highly desirable from the pollution and operating cost perspectives.

While, in the ideal situation, regenerative braking is used at any opportunity (e.g., when industrial electric vehicle 100 goes downhill and/or when industrial electric vehicle 100 needs to slow down), various limitations can exist. One specific limitation is the current SOC of battery 110. Any electrical energy generated during the regenerative braking needs to be consumed (e.g., stored in battery 110 for future use and/or dumped into the environment). It should be noted that battery 110 needs to have enough available capacity (e.g., the state of charge needs to be below SOC_{MAX}) for this energy to be stored. In some examples, a predictive algorithm can be used to predict a SOC profile of battery 110 along route 190. Another predictive algorithm can be used to predict a power output profile associated with regenerative braking. These features are illustrated above with reference to FIGS. 4A and 4B.

In some examples, the SOC and power output profiles can be analyzed together to determine, e.g., the initial SOC of battery 110. More specifically, method 500 can comprise (block) determining the initial SOC of battery 110 based on one or more range-extender portions 195. For example, a starting point of route 190 can have the highest elevation. As industrial electric vehicle 100 leaves this starting point and travels downhill, regenerative braking is available. If battery 110 is fully charged (to SOC_{MAX}) at this point, either the regenerative braking cannot be used or any energy generated from the regenerative braking has to be immediately dumped into the environment. In some examples, regenerative braking is used at all times when possible even if battery 110 cannot be charged (e.g., to reduce the wear of friction brakes 135). In these examples, the power is dumped into the environment by various power-consuming devices 140.

Another target is completing route 190 with battery 110 at a minimum charge state (e.g., SOC about 0%). This target ensures that (1) the overall use of range extender 120 is minimal and, as such, the least amount of fuel is consumed and (2) that battery 110 is not too large for a given application. While an excess battery capacity provides a safety net, a larger battery tends to add to the weight and cost of industrial electric vehicle 100. Furthermore, the electrical energy generated by range extender 120 tends to be more expensive (due to the fuel cost) in comparison to the electrical energy received from external charging station 101 (e.g., grid) and stored in battery 110. Finally, the operation of range extender 120 causes emissions and is generally not desirable. To achieve the minimum charge state of battery 110, range-extender portions 195 can be specifically limited, especially at the end of route 190.

The next target involves minimizing the use of range extender 120 in all range-extender exclusion zones 192 on route 190. As noted above, range-extender exclusion zones 192 can be identified along route 190 based on various noise and/or pollution requirements, e.g., schools, tunnels, parks, quite zones, and the like (e.g., at all times or specific hours). In some examples, different range-extender exclusion zones 192 have different weight coefficients, e.g., corresponding to the importance of not using range extender 120 in that zone. This target may involve predicting a SOC profile of battery 110 along route 190 and ensuring that the SOC level before each range-extender exclusion zone 192 is sufficient to propel industrial electric vehicle 100 through this range-extender exclusion zone 192 (without turning on range extender 120). For example, range extender 120 can be preemptively turned on before approaching one or more range-extender exclusion zones 192 to charge battery 110 to an adequate SOC.

Yet another target is minimizing the non-recoverable energy uses (e.g., the use of friction brakes 135, power dumps, and the like). For example, the energy generated during the regenerative braking can be used for charging battery 110 (e.g., if the SOC is below the maximum level) and/or for power dumping. The energy sent to battery 110 is recoverable (e.g., by discharging battery 110 later), while the power dump to the environment is not. Various examples of power dumps are with the scope, such as running various power-consuming equipment of industrial electric vehicle 100 (e.g., running the heater and air-conditioner at the same time, running auxiliary/peripheral systems such air compressor, power steering, radiator fans, and the like. As such, the state of charge of battery 110 can be managed in such a way that battery 110 is sufficiently discharged to accommodate all or at least some of the regenerated energy (received from electric motor 130 during the regenerative braking). The expected SOC and power output profiles can be analyzed together to determine range-extender portions 195 to achieve this goal.

In some examples, one or more range-extender portions 195 on route 190 are further determined based on one or more external inputs 292 (from external sources 290) comprising at least one of expected weather conditions and expected weight of industrial electric vehicle 100 More generally, range-extender portions 195 can be determined based on factors that are generally not permanently associated with route 190 (such as the distance and grade). These additional factors can also impact the total energy amount needed for industrial electric vehicle 100 to complete route 190. For example, expected weather conditions may impact how much energy will be needed for heating and/or cooling of industrial electric vehicle 100. The expected weight of industrial electric vehicle 100 directly relates to the energy consumption as heavier vehicles require more energy to propel. Furthermore, the weight of industrial electric vehicle 100 can change along route 190 (e.g., industrial electric vehicle 100 being loaded and/or unloaded). Similarly, traffic information also impacts energy consumption. For example, higher speeds may require more energy for a mile traveled. In some examples, some of these inputs are received while industrial electric vehicle 100 is driving along route 190.

In some examples, one or more range-extender portions 195 on route 190 are further determined based on operating instructions 230, received from central data system 210 and developed based operating reports 220 from an industrial electric vehicle fleet previously traveling route 190 (e.g., fleet data 212). Some aspects of this operation are described above with reference to FIG. 3, while additional aspects are described below with reference to block 540.

Method 500 proceeds with (block 530) driving industrial electric vehicle 100 along route 190. During this operation, range extender 120 is instructed to operate while industrial electric vehicle 100 travels through each of one or more range-extender portions 195 on route 190. The process of determining range-extender portions 195 is described above.

In some examples, range-extender portions 195 are fully determined before driving industrial electric vehicle 100 along route 190. In other words, range-extender portions 195 remain the same during the entire driving operation. Alternatively, range-extender portions 195 are updated during this driving operation, e.g., based on one or more route parameters (obtained by industrial electric vehicle 100 while driving) and/or additional information received from central data system 210. Specifically, in some examples, method 500 comprises (block 532) receiving route parameters 191, while (block 530) driving industrial electric vehicle 100 along route 190, and (block 534) determining one or more range-extender portions 195 on route 190, also while (block 530) driving industrial electric vehicle 100 along route 190. For example, receiving route parameters 191 and determining one or more range-extender portions 195 can be performed continuously while driving industrial electric vehicle 100 along route 190. In the same or other examples, receiving route parameters 191 and determining one or more range-extender portions 195 can be performed, at least in part, while driving industrial electric vehicle 100 along route 190. The benefit of performing these operations while driving industrial electric vehicle 100 is that the current state of charge of battery 110 (as well as other vehicle conditions) is known (rather than being predicted) and can be used for determining one or more range-extender portions 195.

In some examples, method 500 comprises (block 540) transmitting operating report 220, e.g., to central data system 210. This operating report can include various route parameters 191 as well as vehicle actual operating parameters, e.g., battery's state of charge along route 190 (e.g., a SOC profile), motor's power profile, range extenders operating profile, power-consuming devices' operating profiles, vehicle speed, operating efficiency, brake activations, motor speed/torque profiles, shift actuations, friction brake activations, temperatures, and the like. This collected data can be used to proactively to flag maintenance issues and/or to feed back into route planning algorithms. For example, route 190 can be penalized based on the number of brake actuations and/or the overall energy consumption. For example, operating reports 220 can be aggregated from a fleet of industrial electric vehicles 100 (as, e.g., is schematically shown in FIG. 3B) and used to generate operating instructions 230 for industrial electric vehicles 100 in this fleet. This approach can be referred to as collective learning about one or more specific routes to which this fleet is assigned.

### Computer System Examples

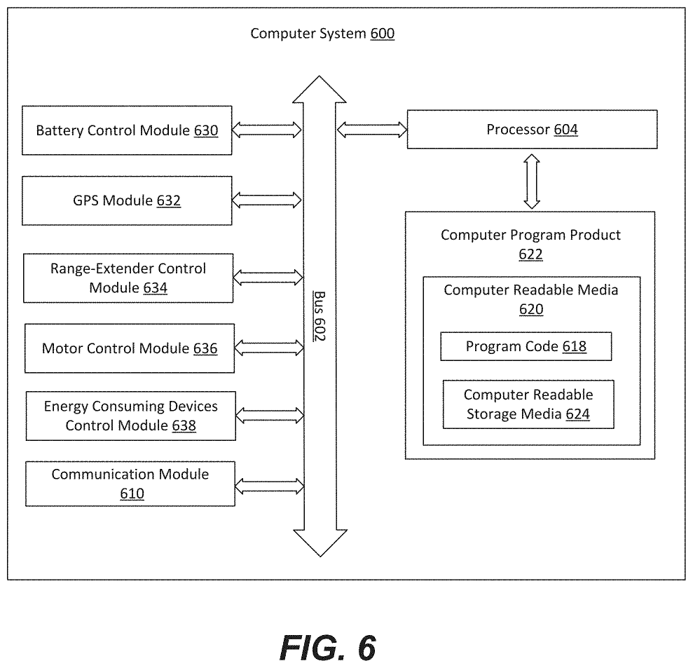

FIG. 6 is a block diagram corresponding to computer system 600 and computer program product 622, which are used to support and implement various functions of industrial electric vehicle 100 and/or central data system 210 described above. Specifically, various components of industrial electric vehicle 100 (e.g., system controller 150) and/or central data system 210 are implementable as and supportable by components of computer system 600 and computer program product 622, e.g., hardware and/or software modules. In some examples, computer system 600 comprises bus 602, which provides communications between processor 604 and various modules. Processor 604 is configured to execute instructions for the software (e.g., computer program product 622).

Various processes of industrial electric vehicle 100 are performed by processor 604 using computer-implemented instructions. These instructions are referred to as program code 618, computer usable program code, or computer-readable program code that is read and executed by a processor in processor 604. Program code in different examples is embodied on different physical or computer-readable storage media. For example, the computer-implemented instructions can be used for determining one or more range-extender portions 195 on route 190 based on at least route parameters 191.

Program code 618 is located in a functional form on computer-readable media 620 that is selectively removable and is loaded onto or transferred to computer system 600 for execution by processor 604. Program code 618 and computer-readable media 620 form or provide computer program product 622 in these illustrative examples. In one example, computer-readable media 620 is or includes computer-readable storage media 624. In these illustrative examples, computer-readable storage media 624 is a physical or tangible storage device used to store program code 618 rather than a medium that propagates or transmits program code 618.

Computer system 600 comprises one or more modules, designed to implement various functions of industrial electric vehicle 100. For example, computer system 600 comprises battery control module 630, which receives and processes (e.g., pre-process/partially process) input from battery 110 such as battery's state of charge, voltage, temperature, and other like parameters. In some examples, computer system 600 comprises GPS module 632, which receives and processes the current location of industrial electric vehicle 100. In some examples, computer system 600 comprises range-extender control module 634, which receives and processes (e.g., pre-process/partially process) any input from range extender 120 as well as prepares and submits instructions to range extender 120 such as one or more range-extender portions 195. In some examples, computer system 600 comprises motor control module 636, which receives input from electric motor 130 and provides instructions to electric motor 130. In some examples, computer system 600 comprises energy-consuming devices control module 638, which provides instructions to various energy-consuming devices 140. Computer system 600 also comprises communications unit 610, which provides communications with other computer systems or devices. For example, communications unit 610 is a network interface card, Bluetooth module, and the like.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered illustrative and not restrictive.

What is claimed is:

1. A method of operating an industrial electric vehicle comprising a battery and a range extender, the method comprising:
receiving route parameters corresponding to a route designated for the industrial electric vehicle;
determining one or more range-extender portions on the route based on at least the route parameters; and
driving the industrial electric vehicle along the route, wherein the range extender is instructed to operate while the industrial electric vehicle travels through each of the one or more range-extender portions on the route.

2. The method of claim 1, wherein the route parameters comprise at least one of:
one or more range-extender exclusion zones on the route;
one or more downhill portions of the route;
one or more uphill portions of the route;
an expected vehicle speed profile along the route;
an expected vehicle weight profile along the route; and
historical traffic information for the route.

3. The method of claim 2, wherein the one or more range-extender exclusion zones comprise at least one of a pollution-restricted area and a noise-restricted area.

4. The method of claim 1, wherein determining one or more range-extender portions on the route is further based on weight coefficients, each assigned to a different one of the route parameters.

5. The method of claim 1, wherein determining one or more range-extender portions on the route is further determined to reduce a total fuel consumption along the route.

6. The method of claim 1, wherein the one or more range-extender portions on the route are further determined based on one or more external inputs comprising at least one of expected weather conditions and expected traffic conditions.

7. The method of claim 1, wherein the one or more range-extender portions on the route are further determined based on operating instructions, received from a central data system and developed based operating reports from an industrial electric vehicle fleet previously traveling the route.

8. The method of claim 1, further comprising, prior to driving the industrial electric vehicle, preconditioning the industrial electric vehicle while the industrial electric vehicle is connected to an external charging station.

9. The method of claim 8, wherein preconditioning the industrial electric vehicle comprises bringing a cabin temperature of the industrial electric vehicle to a set range.

10. The method of claim 1, further comprising determining an initial state of charge of the battery based on the one or more range-extender portions.

11. The method of claim 1, wherein determining the one or more range-extender portions on the route based on the route parameters is performed before driving the industrial electric vehicle along the route.

12. The method of claim 1, wherein receiving the route parameters and determining the one or more range-extender portions is performed continuously while driving the industrial electric vehicle along the route.

13. The method of claim 1, wherein receiving the route parameters and determining the one or more range-extender portions is performed, at least in part, while driving the industrial electric vehicle along the route.

14. The method of claim 13, wherein determining the one or more range-extender portions, while driving the industrial electric vehicle along the route, is further performed based on a current SOC of the battery.

15. The method of claim 1, further comprising, changing the route to minimize the one or more range-extender portions on the route.

16. The method of claim 1, further comprising, after driving the industrial electric vehicle along the route, transmitting an operating report to a central data system, the operating report comprising the route and the one or more range-extender portions used on the route.

17. The method of claim 1, wherein determining the one or more range-extender portions is performed at the industrial electric vehicle.

18. The method of claim 1, wherein:
determining the one or more range-extender portions is performed at a central data system, commutatively coupled to the industrial electric vehicle; and
the one or more range-extender portions are transmitted to the industrial electric vehicle before or while driving the industrial electric vehicle along the route.

19. An industrial electric vehicle comprising:
a battery;
a range extender; and
a system controller, configured to:
receive route parameters corresponding to a route designated for the industrial electric vehicle,
determine one or more range-extender portions on the route based on the route parameters, and
operate the range extender while the industrial electric vehicle travels through each of the one or more range-extender portions on the route.

20. An industrial electric vehicle system comprising:
a central data system; and
multiple industrial electric vehicles, each communicatively coupled to the central data system and comprising a battery, a range extender, and a system controller, wherein the system controller is configured to:
receive, from the central data system route parameters corresponding to a route designated for the industrial electric vehicle,
determine one or more range-extender portions on the route based on the route parameters, and
operate the range extender while the industrial electric vehicle travels through each of the one or more range-extender portions on the route.
